(19) United States
(12) Patent Application Publication
(10) Pub. No.: US 2010/0053241 A1
(43) Pub. Date: Mar. 4, 2010

(54) Non-interfering flushing method for inkjet printers

(75) Inventors: Kartheek Chandu, Boulder, CO (US); Scott Richard Johnson, Erie, CO (US); Amy E. Buckingham, Berthoud, CO (US); Carl R. Bildstein, Superior, CO (US)

Correspondence Address: InfoPrint Solutions/ Blakely, 1279 Oakmead Parkway, Sunnyvale, CA, 94085-4040, US

(73) Assignee: InfoPrint Solutions Company LLC

(21) Appl. No.: 12/231,086

(22) Filed: Aug. 29, 2008

(51) Int. Cl. B41J 2/165; B41J 29/38

(52) U.S. Cl. 347/9; 347/22

(57) ABSTRACT

A method is disclosed. The method includes receiving an overlay having a flushing pattern to flush nozzles of an inkjet print head, printing a page of print data and flushing the nozzles of the inkjet print head during the printing of the page of print data as indicated by the flushing pattern. The flushing of a nozzle does not occur at a data point of the flushing pattern corresponding to a data point of the page of print data.

### BACKGROUND OF THE INVENTION

1. Field of the Invention

The present invention relates to the field of printing, and in particular, to flushing the nozzles in an inkjet printer.

2. Background

An ink jet printer is as an example of a printing apparatus that ejects droplets of ink onto a recording medium such as a sheet of paper, for printing an image on the recording medium. The ink jet printer includes a head unit having at least one ink jet head provided with an ink cartridge that accommodates the ink. In operation of the head unit, the ink is supplied from the ink cartridge to each ink jet head having ejection nozzles, so that a printing operation is performed by ejection of the ink droplets from selected ejection nozzles.

However, ink jet printers may suffer from a problem of evaporation of solvent from the ink causing an increase in the ink viscosity that leads to nozzle clogging and the inability to fire an ink droplet under normal conditions. A clogged nozzle may not only result in diminished print quality, but it can require the expense of replacing the entire print head. To solve this problem, there has been practiced a so-called “flushing operation” wherein the ink is forcibly discharged from the ejection nozzles which are open in a nozzle surface of each ink jet head.

Several flushing methods in existence have undesirable effects upon image quality. One such flushing method involves printing a line across the bottom of each page to flush the nozzles. In this method, each nozzle produces four large drops forming a wide line across the bottom of the printed page. The drawback of this approach is that it leaves a large black line at the bottom of every page and many customers do not have the post-processing equipment to remove it.

Another method involves randomly firing small drops from all nozzles at a specified frequency throughout the printing of a job. The drawback to this approach is that the indiscriminate firing of the nozzles during the printing can cause excessive background noise and alter the color and accuracy of the printed images.

Intelligent flushing methods exist that lessen the problem of the flushes interfering with image quality, but these methods are also undesirable because they are computationally intensive. Thus, the throughput speed of the printers is negatively affected. One such method involves flushing the color ink dispensing nozzles onto points of the page where black ink will ultimately be printed. By effectively hiding the color ink droplets under black ink from the job data, the image quality may be preserved. However, this method requires additional data processing, slowing down the high speed printing process.

Additional problems exist with the current flushing methods. For instance, current flushing methods require all nozzles to be flushed at the same frequency. This results in wasted ink where a user knows that one color needs to be flushed less frequently than another.

Consequently, what is a needed is a mechanism for flushing the nozzles of an inkjet print head during printing that preserves the integrity of the printed images.

### BRIEF SUMMARY OF THE INVENTION

In one embodiment, a method is disclosed. The method includes receiving an overlay having a flushing pattern to flush nozzles of an inkjet print head, printing a page of print data and flushing the nozzles of the inkjet print head during the printing of the page of print data as indicated by the flushing pattern. The flushing of a nozzle does not occur at a data point of the flushing pattern corresponding to a data point of the page of print data.

In further embodiment, a printer is disclosed. The printer includes a control unit to receive an overlay having a flushing pattern; and an inkjet print head having a plurality of ink nozzles that are flushed according to the flushing pattern during the printing of a page of print data, where the flushing of a nozzle does not occur at a data point of the flushing pattern that corresponds to a data point of the page of print data.

In still a further embodiment, a system includes a print server to process print data received as a print request and a printer. The printer includes a control unit to receive the print data from the print server and to combine the print data with an overlay including a flushing pattern and an inkjet print head having a plurality of ink nozzles that are flushed according to the flushing pattern during the printing of a page of print data, where the flushing of a nozzle does not occur at a data point of the flushing pattern that corresponds to a data point of the page of print data.

### BRIEF DESCRIPTION OF THE DRAWINGS

Embodiments of the present invention may be understood more fully from the detailed description given below and from the accompanying drawings of various embodiments of the invention. The drawings, however, should not be taken to be limiting, but are for explanation and understanding only.

FIG. 1 is a block diagram illustrating one embodiment of a print system.

FIG. 2 is a flow diagram for one embodiment of performing a flushing operation.

FIG. 3 is a flow diagram for one embodiment of merging a flushing layout with print job data.

### DETAILED DESCRIPTION OF THE INVENTION

A non-interfering inkjet printer flushing mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

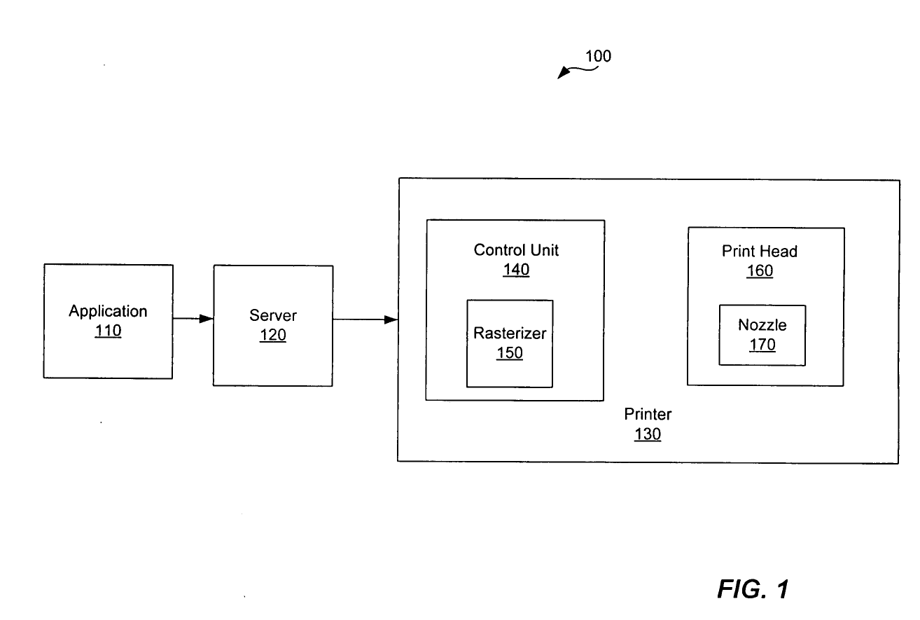

FIG. 1 illustrates one embodiment of a printing system 100. Printing system 100 includes a print application 110, a server 120 and a printer 130. Print application 110 makes a request for the printing of a document. In one embodiment, print application 110 provides a Mixed Object Document Content Architecture (MO:DCA) (also called an Advanced Function Presentation (AFP)) data stream to print server 120.

According to one embodiment, the AFP MO:DCA data streams are object-oriented streams including, among other things, data objects, page objects, and resource objects. In a further embodiment, AFP MO:DCA data streams include a Resource Environment Group (REG) that is specified at the beginning of the AFP document, before the first page. When the AFP MO:DCA data streams are processed by print server 120, the REG structure is encountered first and causes the server to download any of the identified resources that are not already present in the printer. This occurs before paper is moved for the first page of the job. When the pages that require the complex resources are eventually processed, no additional download time is incurred for these resources.

Print server 120 processes pages of output that mix all of the elements normally found in presentation documents, e.g., text in typographic fonts, electronic forms, graphics, image, lines, boxes, and bar codes. The AFP MO:DCA data stream is composed of architected, structured fields that describe each of these elements.

In one embodiment, print server 120 communicates with control unit 140 via an Intelligent Printer Data Stream (IPDS). The IPDS data stream is similar to the AFP data steam, but is built specific to the destination printer in order to integrate with each printer's specific capabilities and command set, and to facilitate the interactive dialog between the print server 120 and the printer. The IPDS data stream may be built dynamically at presentation time, e.g., on-the-fly in real time. Thus, the IPDS data stream is provided according to a device-dependent bi-directional command/data stream.

Printer 130 includes a control unit 140 and a print head 160. Control unit 140 processes and renders objects received from print server and provides sheet maps for printing to print head 160. Control unit 140 includes a rasterizer 150 to prepare pages for printing. Particularly, rasterizer 150 includes a raster image processor (RIP) that converts text and images into a matrix of pixels (bitmap) that will be printed on a page. In one embodiment, print head 160 is a fixed, wide-array inkjet print head including one or more nozzles 170 that are implemented to spray droplets of ink onto a sheet of paper in order to execute a print job. However, print head 160 may include other types of ink jet print heads, as well as a moving print head design.

Although discussed above with regard to receiving data from a print server via AFP and IPDS data formats, printer 130 may receive data (e.g., Portable Document Format (PDF) data) directly from an application 110 interface (e.g., hotfolder, lpr, etc).

As discussed above, nozzles 170 may suffer from an increase in ink viscosity that leads to clogging and the inability to spray ink. Therefore, a flushing operation is performed at printer 130 in order to forcibly discharge ink from the nozzles. According to one embodiment, printer 130 receives an overlay having a flushing pattern indicating which of the nozzles 170 are to be flushed. Thus, the flushing pattern is designed as an overlay for customer applications. An overlay is a set of predefined data in PDF or AFP used with print output. The overlay may include text and/or graphics and is typically merged with variable data.

In a further embodiment, the overlay specifies the frequency at which particular nozzles are to be flushed so that each nozzle may have a separate frequency. Further, the colors of the flushing pattern corresponding to a nozzle may be masked separately to allow for the flushing frequency to be changed on an individual color basis.

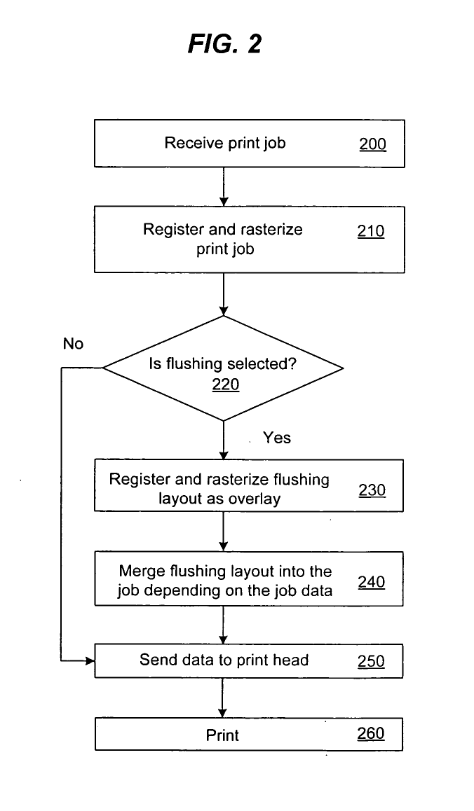

FIG. 2 is a flow diagram illustrating one embodiment of performing a flushing operation. At processing block 200 a print job is received. At processing block 210, the print job is registered and rasterized according to typical print processing. At decision block 220, an overlay is referenced to determine whether flushing process is activated or selected. If flushing is not selected, the rasterized print data is forwarded to print head 160 for printing, processing block 250. Subsequently, the data is printed at processing block 260.

However if flushing is selected, at processing block 220, the flushing layout is registered and rasterized at 230. According to one embodiment, the flushing pattern is halftoned in the overlay design process and compensated to ensure every nozzle is fired after the printer-embedded halftoning is completed. In a further embodiment, the developed flushing pattern has blue noise characteristics that make it less visible to the eye. The term “blue noise” refers to an unstructured pattern with negligible low frequency noise components that produce a fine, visually appealing arrangements of dots.

At processing block 240, the flushing layout and print job are merged. Merging the overlay with the print data occurs such that a data point of the overlay is not included where there exists a corresponding data point in the print data. Because the merging of the overlay with the print data is not computationally intensive, there is no slow down of the throughput of printer 130.

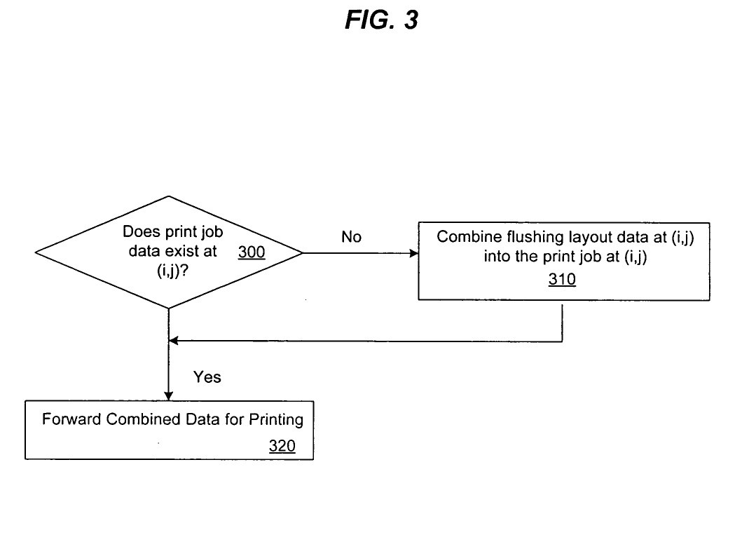

FIG. 3 is a flow diagram illustrating one embodiment of merging a flushing layout with print job data. For every point (i,j) of a page to be printed, it is determined whether print job data exists, at decision block 300. If print job data exists, the flushing data is combined with the print job data such that a point at (i,j) of flushing layout data is combined into the print job data if the print job data does not already contain a data point at (i,j). At processing block 320, the combined data is forwarded for printing.

Where a nozzle is set to flush according to the flushing pattern, that flushing will be ignored if there exists job data at a point (i,j) from the customer application at the position on the page where the flushing is set to occur. Thus, the flushing does not directly interfere with the integrity of the original print data, and where the flushing does occur, the blue noise characteristics reduce the visibility of the flushing pattern, resulting in minimized impact on the image integrity of the original print job.

Referring back to FIG. 2, control is forwarded to processing block 250 after the merging, where the merged data is forwarded to print head 160 for printing. The data is then printed at processing block 260.

The above-described mechanism uses an overlay including a flushing pattern that randomly fires all nozzles with small drops at a specified frequency.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed:

1. A method comprising:
receiving an overlay having a flushing pattern to flush nozzles of an inkjet print head;
printing a page of print data; and
flushing the nozzles of the inkjet print head during the printing of the page of print data as indicated by the flushing pattern, wherein the flushing of a nozzle does not occur at a data point of the flushing pattern corresponding to a data point of the page of print data.

2. The method of claim 1, further comprising combining flushing layout data in the overlay with print data for each point on a page to be printed.

3. The method of claim 1, wherein the flushing pattern includes a flushing frequency for each nozzle of the inkjet print head.

4. The method of claim 2, wherein the flushing frequency for a first nozzle is independent of the flushing frequency for a second nozzle.

5. The method of claim 1, wherein the flushing pattern comprises blue-noise characteristics.

6. The method of claim 1, wherein the flushing is stored in a machine readable format that is convertible to an overlay form.

7. The method of claim 1, further comprising rasterizing the flushing pattern.

8. A system comprising:
a print application; and
a printer including:
a control unit to receive print data from the print application and to combine the print data with an overlay including a flushing pattern; and
an inkjet print head having a plurality of ink nozzles that are flushed according to the flushing pattern during the printing of a page of print data, wherein the flushing of a nozzle does not occur where a data point of the flushing pattern corresponds to a data point of the page of print data.

9. The system of claim 8, further comprising a print server to to process print data received from the print application.

10. The system of claim 8, wherein the flushing pattern includes a flushing frequency for each nozzle of the inkjet print head.

11. The system of claim 10, wherein the flushing frequency for a first nozzle is independent of the flushing frequency for a second nozzle.

12. The system of claim 8, wherein the flushing pattern has blue-noise characteristics.

13. The system of claim 8, wherein the flushing is stored in a machine readable format that is convertible to an overlay form.

14. The system of claim 7, wherein the control unit rasterizes the flushing pattern.

15. A printer comprising:
a control unit to receive an overlay having a flushing pattern; and
an inkjet print head having a plurality of ink nozzles that are flushed according to the flushing pattern during the printing of a page of print data, wherein the flushing of a nozzle does not occur at a data point of the flushing pattern that corresponds to a data point of the page of print data.

16. The printer of claim 15, wherein the control unit combines flushing layout data in the overlay with print data for each point on a page to be printed.

17. The printer of claim 15, wherein the flushing pattern includes a flushing frequency for each nozzle of the inkjet print head.

18. The system of claim 17, wherein the flushing frequency for a first nozzle is independent of the flushing frequency for a second nozzle.

19. The printer of claim 15, wherein the flushing pattern has blue-noise characteristics.

20. The printer of claim 15, wherein the control unit rasterizes the flushing pattern.
